(19) United States
(12) Patent Application Publication
(10) Pub. No.: US 2018/0102733 A1
(43) Pub. Date: Apr. 12, 2018

(54) DYNAMIC RECONFIGURATION OF SOLAR PANELS BASED ON LIGHT CONDITION

(71) Applicant: Sohrab Peshoton Kakalia, FREMONT, CA (US)

(72) Inventor: Sohrab Peshoton Kakalia, FREMONT, CA (US)

(21) Appl. No.: 15/287,684

(22) Filed: Oct. 6, 2016

(51) Int. Cl. H02S 20/32; H02S 50/00; H02J 3/38; H02J 3/40

(52) U.S. Cl. CPC H02S 20/32; H02J 3/40; H02J 3/383; H02S 50/00

(57) ABSTRACT

The system and method for reconfiguring the electrical connections of solar panels based on the light condition is presented. The system measures the intensity or irradiance of the ambient light at the solar panels. Based on the measurement, the solar panels are electrically connected in either series or parallel. A switch unit operates the reconfiguration of the electrical connections among the solar panels. The selective reconfiguration of the solar panels provides extended power generation hours and optimizes the power production of the solar panels.

### BACKGROUND

### Field of the Invention

The subject matter described herein relates generally to photovoltaic panel management device. More specifically, the present disclosure is related to configuring electrical connections among photovoltaic panels.

### Description of Related Art

A photovoltaic panel or solar panel consists of multiple solar cells to produce energy from sun light. The arrangement of solar panels or solar strings can determine power production level that the entire solar panels produces. Various arrangements of solar panels are available nowadays.

Generally, the conventional installation of solar panels applies the same topological configuration to the photovoltaic panels despite of the changing conditions of its surroundings. Once the photovoltaic panels are installed, their topological configuration is permanent and unchangeable. The configuration of solar panels are set during the initial installation and remains as they are even in low light conditions or bad weather conditions, such as dawn, dusk, and overcast weather. The conventional configuration of fixed solar panels, whether on a ground mounted, rooftop or tracking structure, does not account for changing ambient light condition at the installation location. Further, reconfiguring the interconnection (topology) of individual cells or module arrangements generally requires reinstallation of the solar modules. Thus, the conventional photovoltaic panel's electrical configuration is not dynamic and its reconfiguration, once installed, can be cumbersome.

Therefore, what is needed is a method and apparatus that dynamically reconfigures photovoltaic panel arrangements to generate required DC parameters and to generate AC electricity output, based on ambient light condition/weather condition. There also is a need for a system and method for reconfigurable solar panels, that efficiently generate power and increase power generation time, based on changing light condition at the solar panels.

### SUMMARY

The subject matter of this application may involve, in some cases, interrelated products, alternative solutions to a particular problem, and/or a plurality of different uses of a single system or article.

In one aspect, a system for electrical reconfiguration of solar panels is provided. The system comprise a plurality of solar panels, a light measuring unit, a switch unit, and a control unit. Each of the plurality of solar panels may comprise one or more solar modules electrically connected to one another in a first configuration, where the first configuration is a series configuration. The light measuring unit may be positioned to measure incoming light at the plurality of solar panels. The light irradiance of the incoming light may be measured by the light measuring unit. The switch unit may be electrically connected to the plurality of solar panels to selectively reconfigure the plurality of solar panels from the first configuration to a second configuration. The second configuration may be a parallel configuration or any other electrical circuit topologies.

The control unit may be in communication with one or more processors and a data storage unit. The control unit may receive the light irradiance measured by the light measuring unit. The measured light irradiance may be compared with a preconfigured threshold irradiance stored at the data storage unit. Further, the control unit may operate the switch unit to reconfigure the plurality of solar panels from the first configuration to the second configuration when the measured light irradiance is below the preconfigured threshold irradiance. Similarly, the control unit may operate the switch unit to reconfigure the plurality of solar panels from the second configuration to the first configuration when the measured light irradiance is equal to or larger than the preconfigured threshold irradiance.

In another aspect, a method for electrical reconfiguration of solar panels, using a control unit in communication with one or more processors and a data storage unit, is demonstrated. A plurality of solar panels, each of which are electrically connected to one another in a first configuration is provided. The first configuration may be a series configuration. Each of the plurality of solar panels may comprise one or more solar modules in electrical communication with one another. The method may begin with measuring incoming lights at the plurality of solar panels with a light measuring unit. The light measuring unit may measure a light irradiance of the incoming light. A switch unit may selectively reconfigure the plurality of solar panels from the first configuration to a second configuration, where the second configuration may be a parallel configuration or any other electrical circuit topologies. The switch unit may be electrically connected to the plurality of solar panels.

The method may continue with the step of receiving the light irradiance measured by the light measuring unit by the control unit. The light measuring unit may be in communication with the one or more processors. The control unit may further compare the measured light irradiance with a preconfigured threshold irradiance stored at the data storage unit. Further, the control unit may operate the switch unit to reconfigure the plurality of solar panels from the first configuration to the second configuration when the measured light irradiance is below the preconfigured threshold irradiance. Similarly, the control unit may operate the switch unit to reconfigure the plurality of solar panels from the second configuration to the first configuration when the measured light irradiance is equal to or larger than the preconfigured threshold irradiance.

### BRIEF DESCRIPTION OF THE DRAWINGS

FIG. 1 provides a block diagram showing a high-level system architecture.

FIG. 2 provides a block diagram showing an exemplary embodiment of the system architecture.

FIG. 3 provides a block diagram showing an exemplary embodiment of the multiple switch unit placement.

FIG. 4 provides a block diagram showing an exemplary embodiment of a single switch unit placement.

FIG. 5 provides a block diagram showing an exemplary embodiment of the system for electrical reconfiguration of solar panels.

FIG. 6 provides an exemplary illustration of solar panel arrangements and switch configurations.

FIG. 7 provides a flowchart showing an exemplary embodiment of the solar panel reconfiguration.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

In referring to the description, specific details are set forth in order to provide a thorough understanding of the examples disclosed. In other instances, well-known methods, procedures, components, and materials have not been described in detail as not to unnecessarily lengthen the present disclosure.

It should be understood that if an element or part is referred herein as being “on”, “against”, “in communication with”, “connected to”, “attached to”, or “coupled to” another element or part, then it can be directly on, against, in communication with, connected, attached or coupled to the other element or part, or intervening elements or parts may be present. When used, the term “and/or”, includes any and all combinations of one or more of the associated listed items, if so provided.

The terminology used herein is for the purpose of describing particular embodiments only and is not intended to be limiting. As used herein, the singular forms “a”, “an”, and “the”, are intended to include the plural forms as well, unless the context clearly indicates otherwise. It should be further understood that the terms “includes” and/or “including”, when used in the present specification, specify the presence of stated features, integers, steps, operations, elements, and/or components, but do not preclude the presence or addition of one or more other features, integers, steps, operations, elements, components, and/or groups thereof not explicitly stated.

Various operations may be described as multiple discrete operations in turn, in a manner that may be helpful in understanding embodiments; however, the order of description should not be construed to imply that these operations are order dependent.

Spatially relative terms, such as “under” “beneath”, “below”, “lower”, “above”, “upper”, “proximal”, “distal”, and the like, may be used herein for ease of description and/or illustration to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable. Such descriptions are merely used to facilitate the discussion and are not intended to restrict the application of disclosed embodiments.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

Some embodiments of the present invention may be practiced on a computer system that includes, in general, one or a plurality of processors for processing information and instructions, RAM, for storing information and instructions, ROM, for storing static information and instructions, a database such as a magnetic or optical disk and disk drive for storing information and instructions, modules as software units executing on a processor, an optional user output device such as a display screen device (e.g., a monitor) for display screening information to the computer user, and an optional user input device.

As will be appreciated by those skilled in the art, the present examples may be embodied, at least in part, a computer program product embodied in any tangible medium of expression having computer-usable program code stored therein. For example, some embodiments described below with reference to flowchart illustrations and/or block diagrams of methods, apparatus (systems) and computer program products can be implemented by computer program instructions. The computer program instructions may be stored in computer-readable media that can direct a computer or other programmable data processing apparatus to function in a particular manner, such that the instructions stored in the computer-readable media constitute an article of manufacture including instructions and processes which implement the function/act/step specified in the flowchart and/or block diagram. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the following description, reference is made to the accompanying drawings which are illustrations of embodiments in which the disclosed invention may be practiced. It is to be understood, however, that those skilled in the art may develop other structural and functional modifications without departing from the novelty and scope of the instant disclosure.

The system for electrical reconfiguration of solar panels may comprise one or more computers, computerized elements, or programmable electronics in communication with one another, working together to carry out the different functions of the system. The invention contemplated herein may further comprise a non-transitory computer readable media configured to instruct a computer or computers to carry out the steps and functions of the system and method, as described herein. In some embodiments, the communication among the one or more computer or the one or more processors alike, may support a plurality of encryption/decryption methods and mechanisms of various types of data.

The system may comprise a computerized user interface provided in one or more computing devices in networked communication with each other. The computer or computers of the computerized user interface contemplated herein may comprise a memory, processor, and input/output system. In some embodiments, the computer may further comprise a networked connection and/or a display screen. These computerized elements may work together within a network to provide functionality to the computerized user interface. The computerized user interface may be any type of computerized interfaces known in the art capable of allowing a user to input data and receive a feedback therefrom. The computerized user interface may further provide outputs executed by the system contemplated herein.

Database and data contemplated herein may be in the format including, but are not limiting to, XML, JSON, CSV, binary, over any connection type: serial, Ethernet, etc. over any protocol: UDP, TCP, and the like.

Computer or computing device contemplated herein may include, but are not limited to, virtual systems, Cloud/remote systems, desktop computers, laptop computers, tablet computers, handheld computers, smartphones and other cellular phones, and similar internet enabled mobile devices, digital cameras, a customized computing device configured to specifically carry out the methods contemplated in this disclosure, and the like.

Network contemplated herein may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or sub-networks, each of which may include, for example, a wired or wireless data pathway. The network may include a circuit-switched voice network, a packet-switched data network, or any other network able to carry electronic communications. Examples include, but are not limited to, Picture Transfer Protocol (PTP) over Internet Protocol (IP), IP over Bluetooth, IP over WiFi, and PTP over IP networks (PTP/IP).

The system for electrical reconfiguration of solar panels, as described herein, may implement a server. The server may be implemented as any of a variety of computing devices, including, for example, a general purpose computing device, multiple networked servers (arranged in cluster or as a server farm), a mainframe, or so forth. The server may be installed, integrated, or operatively associated with the system. The server may store various data in its database.

In one embodiment, the system for electrical reconfiguration of solar panels may be implemented as a standalone and dedicated device including hardware and installed software, where the hardware is closely matched to the requirements and/or functionality of the software.

In another embodiment, the system for electrical reconfiguration of solar panels may be installed on or integrated with a network appliance configured to establish the network among the components of the system. The system and the network appliance may be capable of operating as or providing an interface to assist exchange of software instructions and data among the components of the system. In some embodiments, the network appliance may be preconfigured or dynamically configured to include the system integrated with other devices.

In yet another embodiment, the system for electrical reconfiguration of solar panels may be installed on or integrated with the server. The server may include the module, which enables the server being introduced to the network appliance, thereby enabling the network appliance to invoke patient behavior and health monitoring as a service. Examples of the network appliance include, but are not limited to, a DSL modem, a wireless access point, a router, a base station, and a gateway having a predetermined computing power and memory capacity sufficient for implementing the components of the system.

In a further embodiment, the system for electrical reconfiguration of solar panels may be installed on or integrated with one or more devices such as a computing device. For example, a smartphone or a tablet with an integrated camera may be implemented in the system to perform the functionalities of the system disclosed herein.

In a further embodiment, the system for electrical reconfiguration of solar panels may be integrated with any number of devices in a distributed fashion.

The system for electrical reconfiguration of solar panels may be implemented in hardware or a suitable combination of hardware and software. In some embodiments, the system may be a hardware device including processor(s) executing machine readable program instructions for analyzing data, and interactions between the components of the system. The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors.

The processor(s) may include, for example, microprocessors, microcomputers, microcontrollers, digital signal processors, central processing units, state machines, logic circuits, and/or any devices that manipulate signals based on operational instructions. Among other capabilities, the processor(s) may be configured to fetch and execute computer readable instructions in a memory associated with the system for performing tasks such as signal coding, data processing input/output processing, power control, and/or other functions. The system may include modules as software units executing on a processor.

The system for electrical reconfiguration of solar panels may include, in whole or in part, a software application working alone or in conjunction with one or more hardware resources. Such software applications may be executed by the processor(s) on different hardware platforms or emulated in a virtual environment. Aspects of the system, disclosed herein, may leverage known, related art, or later developed off-the-shelf software applications. Other embodiments may comprise the system being integrated or in communication with a mobile switching center, network gateway system, Internet access node, application server, IMS core, service node, or some other communication systems, including any combination thereof. In some embodiments, the components of system may be integrated with or implemented as a wearable device including, but not limited to, a fashion accessory (e.g., a wrist band, a ring, etc.), a utility device (a hand-held baton, a pen, an umbrella, a watch, etc.), a body clothing, or any combination thereof.

The system for electrical reconfiguration of solar panels may include a variety of known, related art, or later developed interface(s) (not shown), including software interfaces (e.g., an application programming interface, a graphical user interface, etc.); hardware interfaces (e.g., cable connectors, a keyboard, a card reader, a barcode reader, a biometric scanner, an interactive display screen, etc.); or both. The system may operate in communication with a data storage unit.

Generally, the present invention concerns a system and method for electrical reconfiguration of solar panels based on light (radiation) condition. The system may reconfigure the solar panels' initial electrical configuration (electrical topology) based on a measurement of light intensity or irradiance. The incoming light may be measured at the near proximity of the solar panels or at the solar panels. Various properties of light or sun radiation that entails solar power output may be measured. In some embodiments, intensity, irradiance, and/or brightness of the incoming light may be measured.

The electrical reconfigurations of solar panels carried out by the system may selectively change topological configuration of the solar panel's electrical connections, such as switching between parallel to series, and vice versa. As a result, the electrical configuration of the solar panels may be optimized to efficiently operate the solar panels during varying light conditions, such as low and high light irradiance conditions.

The dynamic reconfiguration of electrical topology on individual solar cells, panels, strings, and arrays can provide the minimum voltage and current requirements for DC to AC inverters to function under unfavorable weather conditions, such as low light condition. In turn, power production time and/or power production efficiency can be extended benefit in number of hours and units of electricity produced. Extended power production hours of existing or new solar production plants in small KW, MW or GW scale can be achieved via the system and method of the present disclosure. Estimated power production can increase between 3-10% and even higher under low light condition. The system of the present disclosure can be retrofitted on existing solar power systems and added to newly developed solar systems.

In a preferred embodiment, the system of the present disclosure is applied to solar panels. Nonetheless, the system and method of the present disclosure may be applied to various voltage sources, power source, power supply devices, and the like.

The reconfiguration of electrical topology may be applied to various units of solar cells. The electrical configurations (topology) across cells, modules, strings, and arrays may be reconfigured by implementing the system and method of the present disclosure. In the present disclosure, a solar panel may comprise one or more solar modules electrically connected to one another. A plurality of these solar panels may be electrically connected to one another. Each solar module may comprise one or more solar cells connected in various configurations, such as series, parallel, or combinations of series and parallel. As such, electrical configurations among individual cells, modules and panels may be reconfigured to provide an optimum voltage and current settings under a low light condition. Those having ordinary skill in the art would readily understand the possible variations, combinations, and permutations of solar panels' electrical connectivity.

Similarly, various electrical topologies (configurations) may be applied to the solar panels, for example, series, parallel, and series-parallel combinations among the solar panels in various levels. Such various electrical topologies may be initially configured in one setting and reconfigured into another setting in order to produce higher current and/or voltage. The present disclosure provides reconfiguration of topologies that adopts to changing weather conditions, such as light conditions, in order to efficiently manage the solar power production.

The reconfiguration of the solar panels electrical connectivity may be operated by a control device or any other control units that is capable of processing information, such as light measurement, switch control logic, etc. The reconfiguration of the solar panels may be automatically carried on based on an instruction provided by one or more controllers, micro controllers, processors, microprocessors, a logic chip, a logic circuit, computing devices and the like. Such logic may be preconfigured, preprogrammed, and/or editable. Alternatively, the reconfiguration of the solar panels electrical connectivity may be operated manually by a human operator using a computerized user interface via a computing device. The computerized user interface may be in communication with the control device via a network to remotely operate the reconfiguration of the solar panels. The computerized user interface may also provide a connection to the Internet for operating any web applications. Further, a data storage unit may be provided to communicate with control device. The data storage unit may store various information pertaining to the operation of the system and method of the present disclosure.

The terms “controller” and “processor” contemplated herein are may be interchangeable, and refer to a central processing unit, a microprocessor, a microcontroller, a microcomputer, a programmable logic controller, controller, a computing device, and the like.

A system for electrical reconfiguration of solar panels is provided. The system may reconfigure electrical connections of the solar panels from one state to another. The system may comprise a plurality of solar panels, a light measuring unit, a switch unit, and a control unit.

The system may reconfigure the initial electrical configuration to another electrical configuration. As discussed above, such reconfiguration may be applied to various levels of solar panel's cell components. The solar panels may be electrically connected to one another in a first configuration. The first configuration may be the initial electrical configuration as initially installed. The first configuration may also refer to the current electrical configuration of the solar panels.

In one embodiment, the first configuration may be a series configuration. The solar panels may be connected to one another in series. In another embodiment, the first configuration may be a parallel configuration. The solar panels may be connected to one another in parallel. In yet another embodiment, the first configuration may be a combination of series and parallel configurations with each interconnects or groups of interconnects among the plurality of solar panels having varying electrical configuration. As such, various types of electrical topology at various levels of solar cell groupings may be initially configured.

The first configuration may be reconfigured to a second configuration by the switch unit. The second configuration may be any types of electrical configuration of the solar panels that is different from the first configuration. The switch unit may selectively reconfigure the electrical topology of the solar panels from the first configuration to the second configuration. Similarly, the switch unit may selectively reconfigure the electrical topology of the solar panels from the second configuration to the first configuration. In some embodiments, there may be more than two configurations (the first configuration and the second configuration). Any number of configuration types may be possible and the switch unit may be operable to reconfigure the electrical topology of the solar panels into any number of configuration types.

The switch unit may reconfigure the electrical interconnects among solar panels either partially or collectively. All of the electrical connections among the solar panels may be reconfigured from one type to another. Similarly, part(s) of the electrical connections may be reconfigured from one type to another.

The switch unit may connect or disconnect any electrical contacts, connection, and interconnects employed by the solar panels' electrical configuration. The switch unit also may establish or discontinue current flow between each of the plurality of solar panels and one or more contacts, connections, and interconnects employed by the solar panel's electrical configuration.

The switch unit may be electrically connected to one or more of the solar panels. The switch unit may be located in a circuit of the solar panels connectivity. The placement of the switch unit may vary depending on which solar panels' electrical connection(s) is being reconfigured. In some embodiments, the switch unit may be placed in between each of the solar panels.

The system may comprise one or more of the switch units. The number of switch units employed by the solar panels circuit and their placements may vary based on the number of solar panels, electrical topology (connection) types, placement of the switch units, location of reconfiguration and/or types of the switch unit. In some embodiments, the switch unit may be placed at each interconnects between every two solar panel. In some embodiments, a single switch unit may be placed to operate the reconfiguration of the plurality of solar panels.

Types of the switch unit may include, but are not limited to, an electrical switch, an electronic switch, a transistor, a solid state device, fuse, anti-fuse, a MOSFETS (metal-oxide semiconductor field-effect transistor), an electromechanical switch, a mechanical switch, a relay, an intermediate switch, a four-way switch, a three-way switch, and a two-way switch; in any contacts types, such as SPST (Single Pole Single Through), SPDT (Single Pole Double Throw), Single Pole Changeover, SPTT (Single Pole Center Off or Single Pole Triple Throw), DPST (Double Pole, Single Throw), DPDT (Double Pole Double Throw), Double Pole Changeover, and Double Pole, and 2P6T (Two Pole, Six Throw).

The switch unit may be electrically connected to a comparator. The system may employ a comparator, such as a threshold comparator, to manage the operation of the switch unit.

The system may reconfigure electrical connections of the solar panels from the first configuration to the second configuration based on varying weather condition, such as light condition. As well known, the power generation level of the solar panels depend greatly on the incoming light (radiation) produced by the Sun. By way of an example, when the light condition is low, there is not enough current to drive the circuit of the solar panels, while there could be sufficient open circuit voltage. In this case, the solar panels may be connected in parallel for a duration of time the light is low. Once the light condition improves the system may switch back to the series configuration.

The light measuring unit may measure light conditions, such as intensity, irradiance, and/or brightness of the incoming light at the solar panels location. The operation of the switch unit may be based on the measurements provided by the light measuring unit. Thus, the measurements provided by the light measuring unit may be the deciding factor to reconfigure electrical connection of the solar panels from the first configuration to the second configuration, and vice versa. In some embodiments, the light measuring unit may measure light condition in a binary manner. The light measuring unit may detect whether there exist any detectable light at the solar panels location.

In some embodiments, the light measuring unit may detect shading conditions on the solar panels. While solar panels are intended to be placed on a location that acquires maximum exposure to sun light, other factors such as shading caused by surrounding objects, such as trees, adjacent building, etc.), and clouds, can affect the amount/level of the incoming light radiating to each of the solar panels.

In some embodiments, the light measuring unit may be in communication with the switch unit relaying light condition(s) measured by the light measuring unit. The light measuring unit may be positioned at a near proximity to the solar panels to accurately measure the light condition radiating to each of the solar panels.

In some embodiments, one or more of the light measuring units may be positioned by the system. The light measuring unit may be sporadically positioned to measure the light condition at multiple spots within the area covered by the solar panels. The light measuring unit may be placed adjacent to each of the solar panel(s). For example, the light measuring unit may be placed at the end of each row of solar panels, each array of solar panels, and/or each strings of solar panels. In some embodiments, the light measuring unit may be integrated with the solar panel. The number of light measuring units employed by the system and their positions/arrangements may vary depending on the number of solar panels, the selection of reconfigurable solar panels, the number of switch units, the placement(s) of switch unit(s), and the like.

The light measuring unit may measure various light conditions, including but not limited to quality, power, brightness, intensity, irradiance, and the like. Accordingly, the measurements may be represented in various units, such as LUX, Lumen, and IRR, for example. Those having ordinary skill in the art would readily understand the various types of light condition measurements that may be applied with the teachings of the present disclosure.

Types of the light measuring unit may include, but are not limited to, a light transducer, a photoconductor, a photodetector, a junction diode, a phototransistor, a light dependent resistor, and the like.

The system may employ an amplifier to boost a signal generated by the light measuring unit. The amplifier may be connected to the light measuring unit. The amplifier may linearly amplify small signals large enough to be measurable by the light measuring unit. The comparator may be in connection with the light measuring unit to actuate the operation of the switch unit. A threshold value may be set by the comparator and the comparator may be operated based a comparison between the threshold value of the comparator and the measurement generated by the light measuring unit.

The system for electrical reconfiguration of solar panels may further comprise a control unit. The control unit may have a processor and a memory. The control unit may manage the operation of the system, specifically the control unit may manage the operation of the switch unit and the light measuring unit. The control unit may be any types of control devices discussed above, situated in various types of networked environment disclosed above.

The control unit may be in communication the switch unit and the light measuring unit. The measurements of the light condition generated by the light measuring unit may be received by the control unit. Further, the control unit may operate the switch unit based on the measurements received from the light measuring unit. The operation of the switch unit and the light measuring unit may be carried out by a logic or an instruction defined by the control unit. Such logic or instruction may be preconfigured and may be editable.

In one embodiment, the control unit comprises an analysis module. The analysis module may compare the measurement from the light measuring unit with a preconfigured threshold value to determine whether reconfiguring the first configuration to the second configuration is necessary. The intensity/irradiance level of the light condition at the solar panels may be compared with a preconfigured threshold irradiance. When the measured irradiance is lower than the preconfigured threshold irradiance, which indicates the light condition is at a lower level, the solar panels may be reconfigured to parallel configuration, for example the second configuration. The control unit may operate the switch unit to reconfigure the electrical connections of the solar panels. The switch unit may be operated by receiving a signal from the control unit. Alternatively, the switch unit may be manually operated based on the analysis carried out by the analysis module of the control unit.

The control unit may use the switch unit to reconfigure the electrical connection of the solar panels to series configuration (the first configuration), when the light intensity measured by the light measuring unit is above or equal to the preconfigured threshold irradiance.

Depending on the number of switch units positioned at the solar panels, the control unit may operate the switch unit individually based on the measured light condition. Further, the control unit may operate a plurality of switch units either individually or collectively based on the light condition measured at each of the solar panels. A suitable electrical configuration of the solar panels may be realized based on the light condition that may vary from one solar panel to another. Additionally, the control unit may also operate the comparator and/or the amplifier.

The control unit or its processor may be in communication with the data storage unit. The data storage unit may store the preconfigured threshold value, such as the preconfigured threshold irradiance. The preconfigured threshold values may be editable, thus can be reset to another value, if needed. The preconfigured threshold irradiance may vary depending on the geographical location of the solar panels, a positioning of the solar panels with regards to the sun, an incident angle of the sunlight at the surface of the solar panels, and the like. Based on such variables, the preconfigured threshold irradiance may be optimized to appropriately set the logic for reconfiguring the solar panels from the first configuration to the second configuration, and vice versa. In one embodiment, the preconfigured threshold irradiance may be 400 IRR.

In some embodiments, the preconfigured threshold irradiance may be programmed by the control unit to change over time. The preconfigured threshold values may be set to change based on time, hours, days, months, seasons, and the like. By way of an example, the preconfigured threshold irradiance may be set to change to a lower value during winter season.

In some embodiment, the preconfigured threshold irradiance may be programmed by the control unit to change based on the ambient temperature and/or the solar panel's temperature. Temperature, in general, is an important factor in solar power management. As such, the ambient temperature and/or the solar panel's temperature may be measured and the measurements may be received by the control unit.

The control unit may be positioned near the solar panels as a standalone unit. A control box may be installed including the control unit. Alternatively, the control unit may be operable via a remote access. The computerized user interface may be in communication with the control unit via a network to remotely carry out the functions of the control unit. In some embodiments, the control unit may be electrically connected with the switch unit and the light measuring unit. The operation of the switch unit and the light measuring unit may be conducted manually.

The data storage unit may further contain information relative in operating the system. A historic data or a data log of the measured light condition and its corresponding operation of the switch unit may be stored by the data storage unit. Such historic data may be utilized to run analytics of the solar panels performance, such as power generation trend. The historic data and its trend may be analyzed by the analysis module to automatically change the preconfigured threshold values over time.

The control unit may further comprise a weather sensing module. The weather sensing module may identify weather conditions at the solar panels location, in addition to the light condition. Weather conditions, such as humidity, due point, temperature, and the like, may be identified by the weather sensing module. Preconfigured threshold levels may be assigned to such measurable weather conditions, in order to optimize the operation of the solar panels. The control unit may control the reconfiguration of electrical connections based on such weather condition measurements. For example, the control unit may set the light measuring unit off after sunset.

The control unit may further comprise a weather forecast module. The control unit may identify weather forecast information, in order to program the logic that operates the reconfiguration of solar panels' electrical topology. Weather forecast, such as amount of clouds, overcast, rain, snow, and the like, may be identified in advance to optimize the preconfigured threshold values. The weather forecast information may be utilized to determine the operation of the system. It may be utilized to determine whether the system should be initiated, how many number of solar panels would remain active, and whether the operation of the light measuring unit is necessary. For example, if the weather forecast information predicts monsoon season for the next few weeks, the control unit may determine to seize the operation of the light measuring unit, and set the switch unit to reconfigure the solar panels in series, for the duration of the monsoon season. Similarly, the control unit may utilized the weather forecast information to identify sunrise time, sunset time, and the like to optimize the operation of the system. The control unit may have access to Internet for such weather forecast information.

The control unit may further comprise a starter module and/or a timer module. The starter module may determine the time in a day, for example, to initiate the operation of the system or its components. The starter module may determine at which light irradiance level the reconfiguration operation begins. The starter module may determine when to initiate, based on the measurements of the light measuring device or other weather sensing modules, the operation sequence of reconfiguring the electrical connection of the solar panels from one configuration to another. For example, the starter module may assign a preconfigured starter irradiance. Once the light irradiance level acquired by the light measuring unit reaches the preconfigured starter irradiance, the control unit may begin the operation sequence of solar panel reconfiguration. The preconfigured starter irradiance may be stored by the data storage unit and editable. For example, the preconfigured starter irradiance may be set to 200 IRR.

The timer module may facilitate a periodic acquisition of light condition measurements from the light measuring unit. The timer module may periodically gather the light condition measurement at a set interval. In some embodiments, the timer module may determine how often the light measuring unit acquires the light condition measurement to compare with the preconfigured starter irradiance. Thus, the timer module may determine how often the light measuring unit is operational. In some embodiments, the time module may determine how often the light measuring unit acquires the light condition measurement to compare with the preconfigured threshold irradiance. The light irradiance may be measured by the light measuring unit periodically at a set interval in order to continually determine the reconfiguration of the solar panels from the first configuration to the second configuration, and vice versa. The set interval may be stored by the data storage unit and may be editable. A periodical acquisition of light condition is necessary to quickly adopt the solar panels electric configuration to its optimal configuration based on changing light condition.

The system for electrical reconfiguration of solar panels may further comprise a user device. The user device may employ the computerized user interface and may be in communication with the data storage unit. The user device may be utilized to change or edit any preconfigured values referenced in operating the system. Further, the user device may be utilized to manually operate control unit and/or its components, such as the switch unit, the light measuring unit, the weather forecast module, the weather sensing module, the starter module, the analysis module, and the timer module.

The description of figures sets forth exemplary embodiments of the system and its functions for constructing and operating the present disclosure in connection with the figures presented herewith.

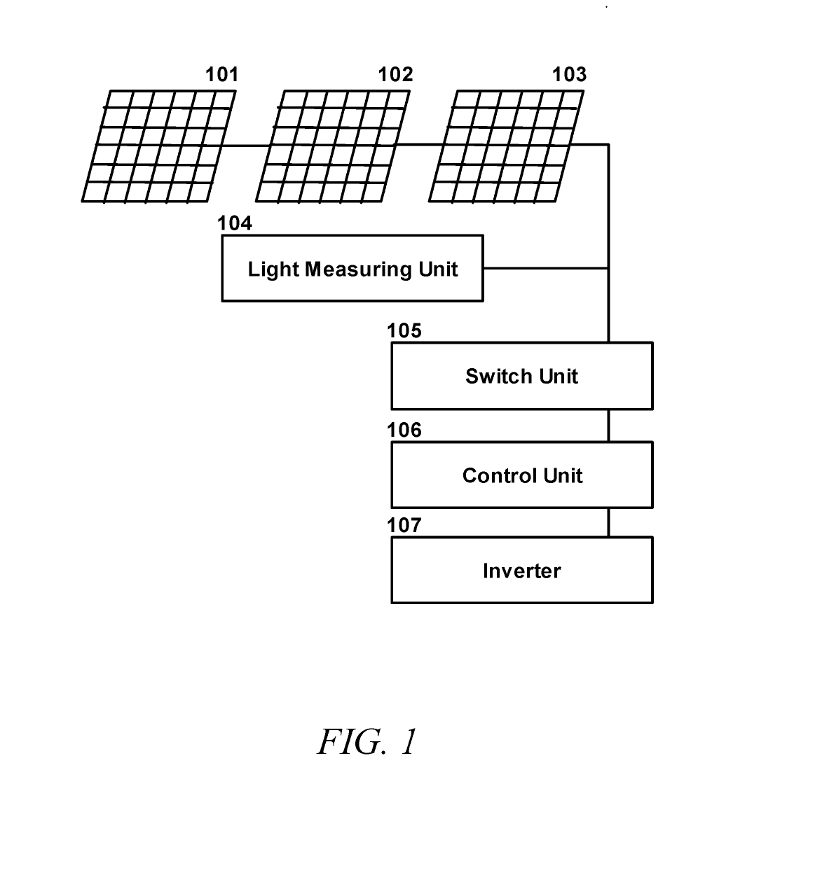

FIG. 1 provides a block diagram showing a high-level system architecture of the system for electrical reconfiguration of solar panels. The solar panels 101 102 103 may be electrically connected to one another. The topology of the electrical connections among the solar panels 101 102 103 are shown in series, however, they may be connected to one another in various electrical connection types. The solar panels 101 102 103 may be in communication with the light measuring unit 104, the switch unit 105, the control unit 106, and an inverter 107. The light measuring unit 104 measure the light condition at the solar panels 101 102 and 103. Based on the measured light condition by the light measuring unit 104 the switch unit 105 may reconfigure the electrical connection among the solar panels 101 102 103 from the first configuration to the second configuration, and vice versa. The control unit 106 operates the switch unit 105 based on a comparison between the measured light condition and the preconfigured threshold value, such as the preconfigured threshold irradiance. As a result, the inverter 107 may change direct current (DC) to alternating current (AC).

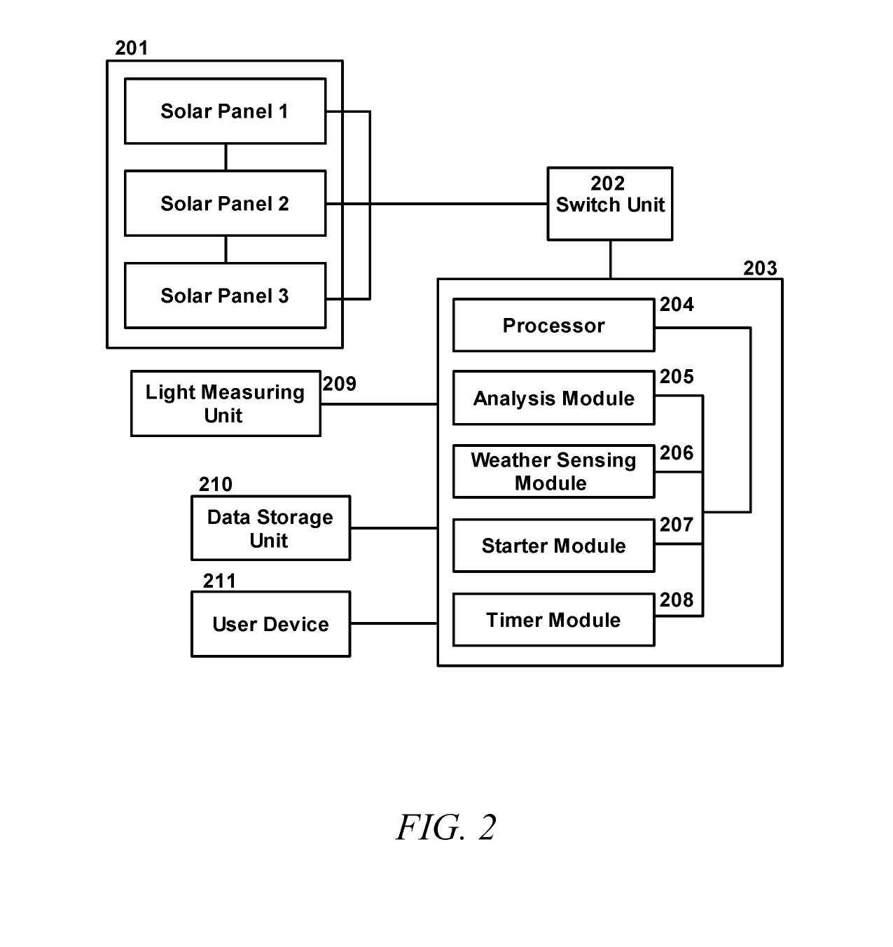

FIG. 2 provides a block diagram showing an exemplary embodiment of the system architecture. The plurality of solar panels are shown at box 201. The plurality of solar panels 201 may be electrically connected to the switch unit 202. The control unit 203 may selectively operate the switch unit 202. The control unit 203 may comprise a processor 204 operating the analysis module 205, the weather sensing module 206, the starter module 207, and the timer module 208. The control unit 203 may be in communication with the light measuring unit 209, which measure the light condition at the location where the plurality of solar panels 201 are installed. Further, the control unit 203 may be in communication with the data storage unit 210 and the user device 211. The switch unit 202 may reconfigure the electrical connections among the plurality of solar panels 201 from the first configuration to the second configuration based on an analysis carried out by the analysis module 205. The analysis module 205 compares the measure light irradiance from the light measuring unit 209 against the preconfigured threshold irradiance stored in the data storage unit 201. The switch unit 202 may enter into a low light mode by reconfiguring the electrical connections among the plurality of solar panels 201 in to parallel, if the measured light irradiance is lower than the preconfigured threshold irradiance. Similarly, the switch unit 202 may enter into a normal light mode by reconfiguring the electrical connections among the plurality of solar panels 201 in to series, if the measured light irradiance is greater than the preconfigured threshold irradiance.

The information acquired by the weather sensing module 206 may be analyzed by the analysis module 205 and assist in determining the operation of the switch unit 202. The starter module 207 may compare the measured light irradiance with the preconfigured starter irradiance. The processor 204 may perform its analysis with the analysis module 205 when the measured light irradiance exceeds the preconfigured starter irradiance. Further, the steps for reconfiguring electrical connections among the plurality of solar panels 201 may not begin until the measured light irradiance exceeds the preconfigured starter irradiance. The measurements of light condition acquired by the light measuring unit 209 may need to be periodically gathered, in order to maintain an optimal electrical connections among the plurality of solar panels 201. Thus, the time module 208 may periodically acquire measurements from the light measuring unit 209 at a set interval. The acquired measurement at each interval may be compared with the preconfigured threshold irradiance to determine whether reconfiguring the solar panels' electrical configuration is needed.

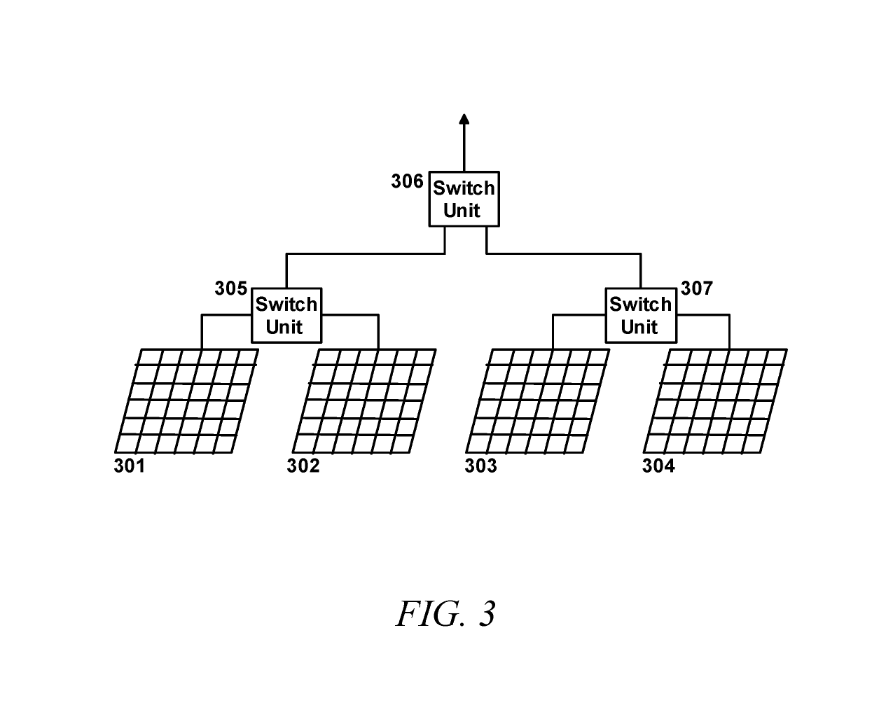

FIGS. 3-6 provides exemplary embodiments of the switch unit configuration. The number of solar panels illustrated in FIGS. 3-6 may vary in accordance with the present disclosure. The solar panel arrangements are shown for the purpose of describing particular embodiments only and is not intended to be limiting. Types of the switch unit may vary in the following exemplary embodiments. Those having ordinary skill in the art would readily understand the possible variations in the configuration of the solar panels and the switch units.

FIG. 3 provides a block diagram showing an exemplary embodiment of the multiple switch units' configuration. Each of the switch units 305 and 307 may be connected to the solar panel circuit, placed in between a set of solar panels. The switch unit 305 is placed in between the solar panels 301 and 302, selectively configuring the electrical connection between solar panels 301 and 302 in series or parallel. The switch unit 307 is placed in between the solar panels 303 and 304, selectively configuring the electrical connection between solar panels 303 and 304. The switch unit 306 may be connected to the switch units 305 and 307. The switch unit 306 may selectively set up electrical connections between each of the groups of solar panels governed by the switch units 305 and 307, namely the solar panels 301 and 302 as one group and the solar panels 303 and 304 as another group. This exemplary embodiment of the multiple switch units' configuration shows a hierarchical relations among the switch units. Such hierarchical set-up of switch units allows selective control of electrical topologies among number of solar panels and enables combinations of series and parallel topologies among groups of solar panels, such as series-parallel or parallel-series, for example. In this embodiment, the switch units 305 306 and 307 may be a MOSFET switch. Each of the switch units 305 306 307 may be individually operated by the control unit. Also, the switch units 305 306 307 may be collectively operated.

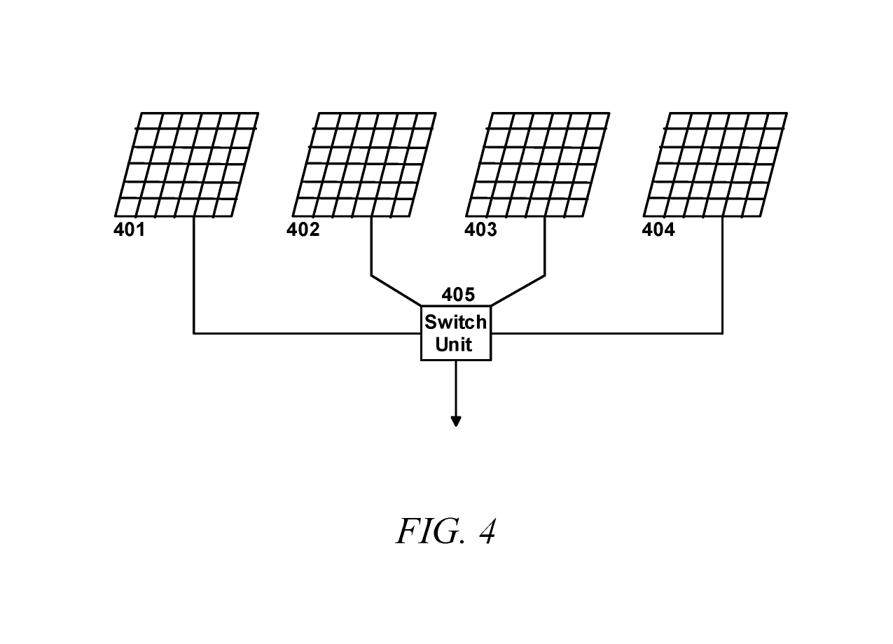

FIG. 4 provides a block diagram showing an exemplary embodiment of a single switch unit placement. In this embodiment, the switch unit 405 may solely reconfigure the electrical connection among the solar panels 401 402 403 404. The switch unit 405 may be a relay type. Based on the setting of the switch unit 405, various topological configurations can be realized among the solar panels 401 402 403 404.

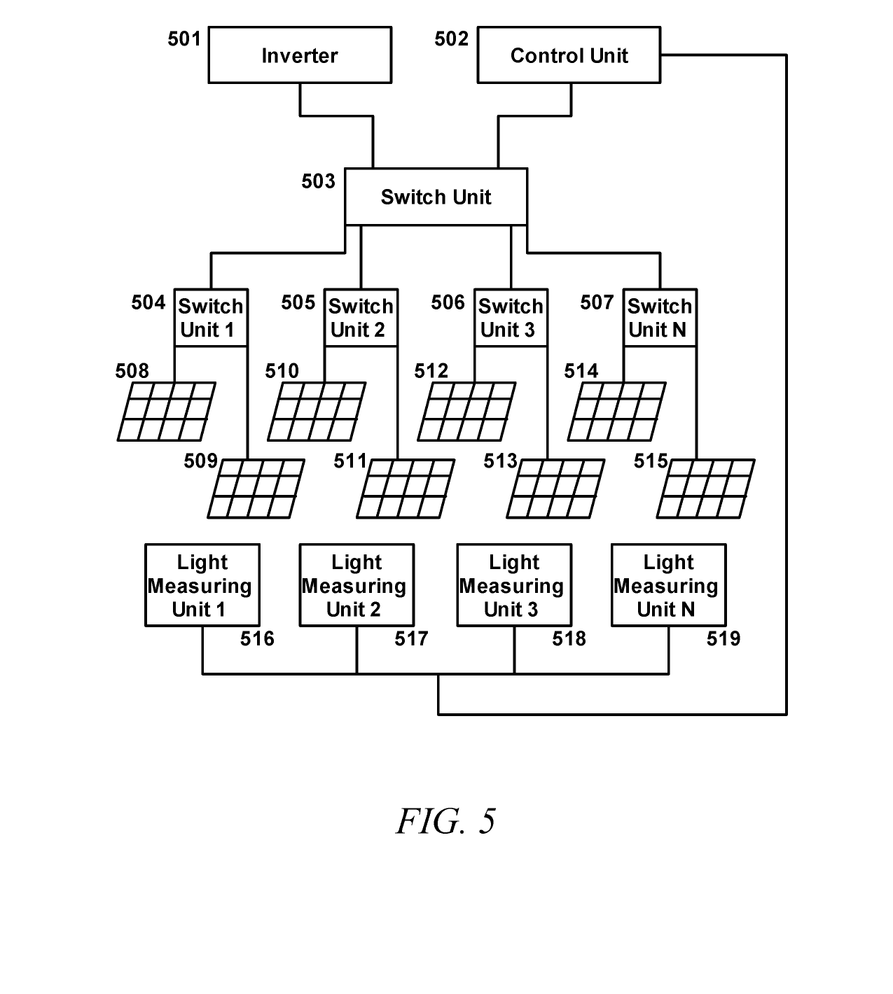

FIG. 5 provides an exemplary embodiment of the system for electrical reconfiguration of solar panels. In this embodiment, switch units are positioned in a hierarchical fashion. The number of, solar panels, switch units, and light measuring units are shown for the purpose of describing a particular embodiment only and is not intended to be limiting. The system for electrical reconfiguration of solar panels of FIG. 5 comprises multiple light measuring units (Light Measuring Unit 1 516, Light Measuring Unit 2 517, Light Measuring Unit 3 518, and Light Measuring Unit N 519). The multiple light measuring units may be in communication with the control unit 502. The measurements of light conditions acquired by the multiple light measuring units may be received by the control unit 502 for selectively reconfiguring the electrical connections of the solar panels 508 509 510 511 512 513 514 515. Each of the multiple light measuring units may be positioned adjacent to each pairs of solar panels. A switch unit may be placed between each pairs of solar panels to configure the electrical connection between the pairs. The switch unit 1 504 is connected to solar panels 508 and 509. The switch unit 2 505 is connected to solar panels 510 and 511. The switch unit 3 506 is connected to solar panels 512 and 513. The switch unit N 507 is connected to solar panels 514 and 515, and so on. The control unit 502 may operate the switch units 504 505 506 and 507. Further, the control unit 502 may operate the switch unit 503, which selectively manages the electrical configurations among switch unit 1 504, switch unit 2 505, switch unit 3 506, and switch unit N 507, either collectively or individually. The control unit 502 may operate the switch units 503 504 505 506 and 507 based on the measurements of light conditions acquired by the multiple light measuring units 516 517 518 and 519. Finally, an inverter 501 may be positioned to receive current output generated by the solar panels 508 509 510 511 512 513 514 515. In one embodiment, the system for electrical reconfiguration of solar panels of FIG. 5 may employ MOSFET switches.

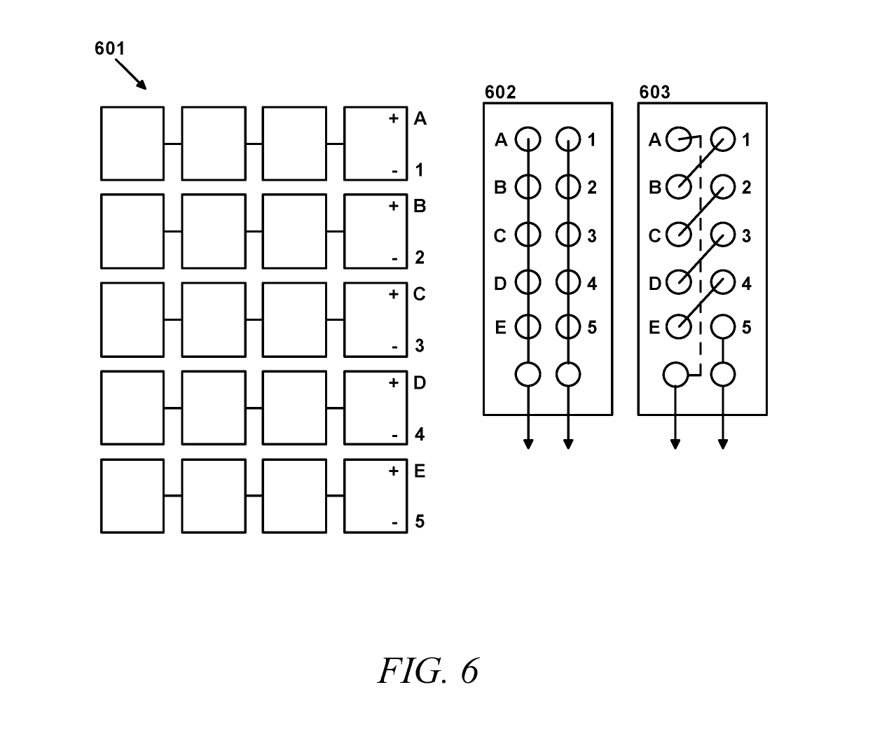

FIG. 6 provides an exemplary illustration of solar panel arrangements and switch configurations. The plurality of solar strings (modules in series) are shown at 601. The box 602 illustrates the low light mode switch configuration, which connects the plurality of solar strings 601 in parallel. As such, the voltage stays constant and a higher current is obtained. The box 603 illustrates the normal light mode switch configuration, which connects the plurality of solar strings 601 in series. In 603, the current stays constant and a higher voltage is generated.

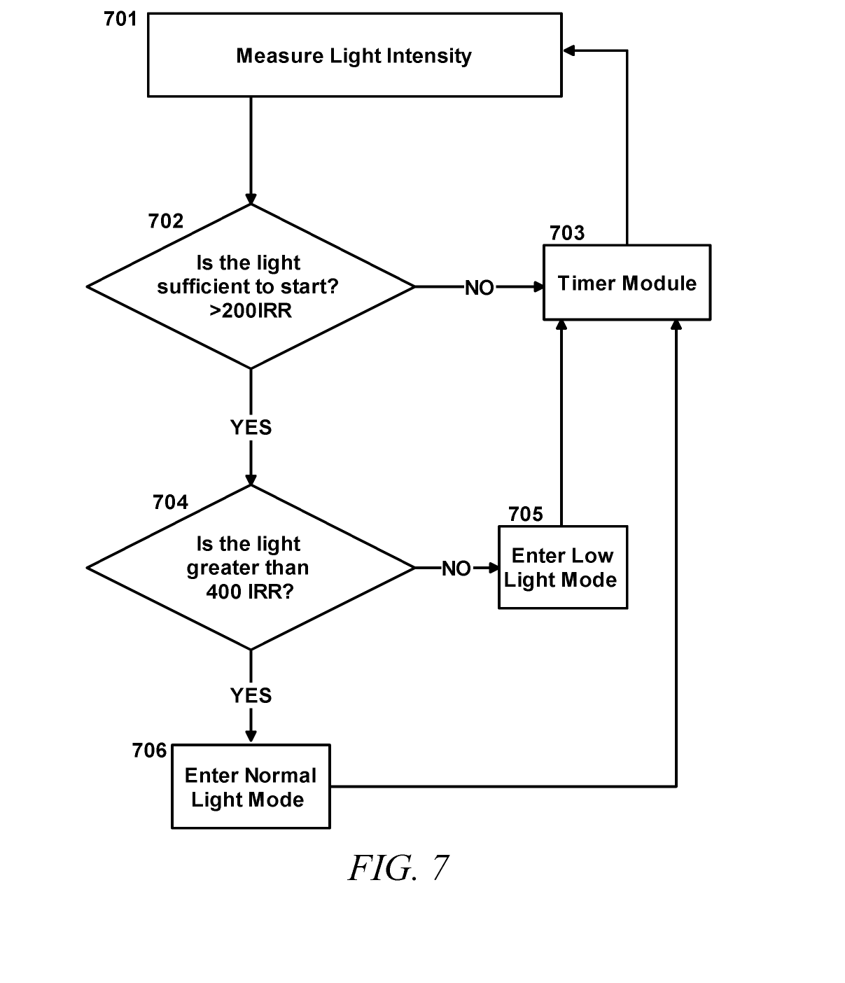

FIG. 7 provides a flowchart showing an exemplary embodiment of the solar panel reconfiguration. The flowchart illustrates an exemplary steps in reconfiguring the electrical connections among the solar panels. The steps shown in FIG. 7 may be carried out by the control unit. At step 701, light intensity is measured by the light measuring unit. The control unit identifies the measured light intensity and compares it with the preconfigured starter intensity at step 702. In this embodiment, the preconfigured starter intensity is set at 200 IRR. If the measured light intensity is above the preconfigured starter intensity the process moves on to the next step 704. If not, a timer is set by the timer module 703 to re-measure the light intensity at a set interval.

At step 704, the measured light intensity is compared against the preconfigured threshold intensity, which is set to 400 IRR in this embodiment. If the measured light intensity is above the preconfigured threshold intensity, the solar panels configuration enters into the normal light mode 706, which is the first configuration (connected in series). If the measured light intensity is below the preconfigured threshold intensity, the solar panels configuration enters into the low light mode 705, which is the second configuration (connected in parallel). At steps 706 and 705, the light intensity is measured continually at a set interval to maintain an optimal electrical configuration of the solar panels in changing light conditions. Once the solar panels configuration enters into the normal light mode at 706, the timer module 703 sets the time interval to restart the process from step 701. Similarly, the timer module 703 sets the time interval to restart the process from step 701, once the solar panels configuration enters into the low light mode at step 705.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

Those skilled in the art will readily observe that numerous modifications, applications and alterations of the device and method. may be made while retaining the teachings the present invention.

What is claimed is:

1. A system for electrical reconfiguration of solar panels, comprising:
a plurality of solar panels, each of the plurality of solar panels comprising one or more solar modules electrically connected to one another, wherein each of the plurality of solar panels are electrically connected to one another in a first configuration, the first configuration being a series configuration.
a light measuring unit positioned to measure incoming light at the plurality of solar panels, wherein the light measuring unit measures a light irradiance of the incoming light;
a switch unit electrically connected to the plurality of solar panels, wherein the switch unit selectively reconfigures the plurality of solar panels between the first configuration and a second configuration, the second configuration being a parallel configuration; and
a control unit in communication with one or more processors and a data storage unit, wherein the control unit is configured to:
receive the light irradiance measured by the light measuring unit, the light measuring unit being in communication with the one or more processors;
compare the measured light irradiance with a preconfigured threshold irradiance, the one or more processors being in communication with the data storage unit, wherein the preconfigured threshold irradiance is stored at the data storage unit; and
operate the switch unit, the one or more processors being in communication with the switch unit, wherein the control unit reconfigures the plurality of solar panels from the first configuration to the second configuration, with the switch unit, when the measured light irradiance is below the preconfigured threshold irradiance.

2. The system of claim 1, wherein the system comprises a plurality of the switch units, each of the plurality of switch units being positioned in-between the plurality of solar panels.

3. The system of claim 2 wherein the control unit is configured to operate each of the plurality of switch units independently.

4. The system of claim 1 wherein the control unit further operates the switch unit to reconfigure the plurality of solar panels from the second configuration to the first configuration when the measured light irradiance is equal to or larger than the preconfigured threshold irradiance.

5. The system of claim 1 wherein the control unit comprises a starter module, the starter module enabling the control unit operable when the measured light irradiance is greater than a preconfigured starter irradiance, the preconfigured starter irradiance being 200 IRR.

6. The system of claim 1 wherein the control unit comprises a timer module, the time module measuring the light irradiance, using the light measuring unit, periodically at a set interval.

7. The system of claim 1 wherein the switch unit is a threshold comparator, the threshold comparator selectively operating the switch unit based on the measured light irradiance.

8. The system of claim 1 further comprising a signal amplifier, the signal amplifier linearly amplifying a signal generated from the light measuring unit.

9. The system of claim 1 further comprising a weather sensing module, wherein the weather sensing module enables the control unit operable based on a weather condition, the weather sensing module acquiring the weather condition, the weather sensing module comprising at least one of:
a weather forecast module acquiring weather forecast information, the weather forecast module in communication with Internet via a network;
a thermometer; and
a humidity sensor.

10. The system of claim 1 wherein the light measuring unit is at least one of:
a photoconductor;
a photodetector;
a junction diode;
a phototransistor;
a light dependent resistor; and
a light transducer.

11. The system of claim 1 wherein the preconfigured threshold irradiance is 400 IRR.

12. A method using a control unit in communication with one or more processors and a data storage unit, for electrical reconfiguration of solar panels, comprising:
providing a plurality of solar panels, each of the plurality of solar panels comprising one or more solar modules electrically connected to one another, wherein each of the plurality of solar panels are electrically connected to one another in a first configuration, the first configuration being a series configuration;
measuring incoming light at the plurality of solar panels with a light measuring unit, wherein the light measuring unit measures a light irradiance of the incoming light;
selectively reconfiguring, with a switch unit electrically connected to the plurality of solar panels, the plurality of solar panels between the first configuration and a second configuration, the second configuration being a parallel configuration;
receiving, with the control unit, the light irradiance measured by the light measuring unit, the light measuring unit being in communication with the one or more processors;
comparing, with the control unit, the measured light irradiance with a preconfigured threshold irradiance, the one or more processors being in communication with the data storage unit, wherein the preconfigured threshold irradiance is stored at the data storage unit; and
reconfiguring the plurality of solar panels from the first configuration to the second configuration, with the switch unit operated by the control unit, the one or more processors being in communication with the switch unit, when the measured light irradiance is below the preconfigured threshold irradiance.

13. The method of claim 12 wherein the step of selectively reconfiguring the plurality of solar panels comprises selectively reconfiguring, between the first configuration and the second configuration, at each relay in-between the plurality of solar panels,

14. The method of claim 12 further comprising the step of enabling the control unit operable, with a starter module in communication with the one or more processors, when the measured light irradiance is greater than a preconfigured starter irradiance, the preconfigured starter irradiance being 200 IRR.

15. The method of claim 12 further comprising the step of reconfiguring the plurality of solar panels from the second configuration to the first configuration, with the switch unit operate by the control unit, when the measured light irradiance is equal to or larger than the preconfigured threshold irradiance.

16. The method of claim 12 further comprising the step of measuring the light irradiance, using the light measuring unit, periodically at a set interval.

17. The method of claim 12 further comprising the step of providing a threshold comparator electrically connected to the switch unit, the threshold comparator selectively operating the switch unit based on the measured light irradiance.

18. The method of claim 12 further comprising the step of providing a signal amplifier, the signal amplifier linearly amplifying a signal generated from the light measuring unit.

19. The method of claim 12 further comprising the step of enabling the control unit operable, with a weather sensing module in communication with the one or more processors, based on a weather condition, the weather sensing module acquiring the weather condition, the weather sensing module comprising at least one of:
a weather forecast module acquiring weather forecast information, the weather forecast module in communication with Internet via a network;
a thermometer; and
a humidity sensor.

20. The method of claim 12 wherein the switch unit is at least one of:
a metal-oxide semiconductor field-effect transistor;
a transistor;
an electromechanical switch;
a mechanical switch;
an electrical switch;
a relay; and
a four-way switch.
